(19) United States
(12) Patent Application Publication
(10) Pub. No.: US 2026/0131241 A1
(43) Pub. Date: May 14, 2026

(54) METHOD AND SYSTEM FOR REPLAY GAMING

(71) Applicant: SIMPLEBET LLC, Boston, MA (US)

(72) Inventors: Trevor Dalglish, Hoboken, NJ (US); Simon Gershey, New Canaan, CT (US); David Bernazal, Austin, TX (US); Adam Legg, Williamsburg, VA (US)

(21) Appl. No.: 19/387,922

(22) Filed: Nov. 13, 2025

Related U.S. Application Data
(60) Provisional application No. 63/719,984, filed on Nov. 13, 2024.

(51) Int. Cl. A63F 13/497

(52) U.S. Cl. CPC A63F 13/497

(57) ABSTRACT

A system for presenting anonymized historical sports markets for wagering, including retrieving historical sports data from a file system, database, in-memory data structure store, or message queue and anonymizing key details, such as team names and player identities. The system and platform include transmitting the anonymized data, including statistics data, to one or more peripheral devices to render and present the anonymized data on a user interface. Users can place wagers on the anonymized events, and the system records these wagers. Once the betting window closes, the system reveals the full event details, including teams, players, and outcomes, allowing users to verify their wagers. The system settles wagers based on the revealed outcomes. Multiple market ordering strategies can be implemented through computing models, offering flexibility in how markets are presented based on user preferences or regulatory requirements. The system provides a secure, fair, and dynamic approach to sports wagering while maintaining transparency and compliance with relevant laws.

### CROSS-REFERENCE TO RELATED APPLICATION

This application claims priority to and the benefit of provisional U.S. Patent Application No. 63/719,984 filed November 13, 2024, which is hereby incorporated herein in its entirety by this reference.

### FIELD OF THE DISCLOSURE

The present disclosure relates generally to a system and a computer platform for event-based predictive interaction, and more particularly to a platform and methodology for presenting anonymized historical event data to users for the purposes of engaging in predictive activities such as forecasting, simulation, or wagering.

### BACKGROUND OF THE DISCLOSURE

Traditional wagering platforms typically focus on live or upcoming events, providing users with full visibility into relevant participants, contextual data, and predictive indicators prior to placing bets. While effective for real-time engagement, these systems offer limited flexibility for wagering based on to historical events. In such cases, outcomes are often determined by random number generators (RNGs), which can shift the regulatory classification in certain applications from event-based wagering to games of chance—introducing additional compliance complexities.

Moreover, conventional systems generally lack personalization and adaptability, relying on static data presentation and fixed market structures. This rigidity can reduce user engagement and limit the platform’s ability to accommodate diverse regulatory frameworks or user preferences. There is a need for a dynamic, secure, and compliant system that enables predictive interaction with historical event data while maintaining fairness and transparency, without relying on RNGs.

### SUMMARY OF THE DISCLOSURE

Embodiments described herein provide systems and methods for presenting anonymized historical sports markets for wagering, offering enhanced flexibility, and compliance with regulatory requirements. The invention allows users to place bets on historical sports events where key details, such as team names and player identities, are anonymized until the market closes, thereby ensuring fairness and preventing predictable outcomes. This system supports multiple market ordering strategies, ensuring flexibility in how users engage with the betting markets.

In some embodiments, a server, coupled to a processor, retrieves historical sports data from a database, anonymizes key event details, and presents relevant statistics, such as a pitcher’s earned run average (ERA) or a batter’s batting average, to the user through a user interface. Users can place wagers on these anonymized events, and the system records the wagers in the database. Once the betting window closes, the full details of the event, including team names, player identities, and the outcome, are revealed to the user. The system then settles the wagers based on the revealed outcomes.

In certain embodiments, the system may use various market ordering strategies, including ordering by timestamps, Universally Unique Identifier (UUID) digits, or customer interaction metrics. The server dynamically selects from available computer modules and allows users to choose their preferred market ordering strategy through the user interface. This enables flexibility in presenting markets while maintaining compliance with varying regulatory requirements across jurisdictions.

In some embodiments, the system provides transparency by allowing users to verify outcomes against third-party data sources. The platform is scalable, using technologies like WebSockets or Server-Sent Events (SSE) to provide real-time updates, and secure, with encryption methods such as AES-256 to protect data in transit and at rest.

By incorporating a computer module suite comprising multiple computer modules for market ordering, historical data anonymization, and post-betting transparency, the system provides a dynamic, personalized, and secure wagering experience that complies with industry regulations. Embodiments are adaptable to different platforms, including mobile and desktop environments, and ensures efficient performance through caching mechanisms and load balancing techniques.

In some embodiments, a sports wagering system for presenting anonymized historical sports markets comprises a server configured to execute instructions to retrieve historical sports data from a database corresponding to a specific sports event, anonymize key details of the data including team names and player identities, and transmit the anonymized data with instructions to a peripheral device equipped with a user interface to render statistics related to the event on the user interface. The system is further configured to receive one or more communication signals containing user wager data from the peripheral devices (for example, user wager data generated in response to interaction by a user with the user interface), store the user wager data in the database, generate and transmit the full details of the event to the peripheral device(s) after the betting window closes, and settle, or facilitate settling, wagers based on the revealed event outcome.

In some embodiments, the server in the system is configured to apply data masking techniques to anonymize identification data such as team names and player identities. The anonymized data transmitted to the peripheral device and presented on the respective user interface can include specific statistics such as a pitcher's ERA and a batter's batting average in some non-limiting examples. Additionally, the server retrieves historical data using an indexing methodology based on a market identifier or event type and may use a machine learning model to recommend sports markets to users based on past interactions with the system. The database stores metadata related to historical sports events, including timestamps and regulatory information, and the server transmits to the peripheral device equipped with user interface live data updates via, for example, WebSockets or Server-Sent Events (SSE).

In some embodiments, a computer-implemented method for presenting anonymized historical sports markets includes retrieving historical sports data from a database, anonymizing key details such as team names and player identities, and transmitting anonymized data with statistics relevant to the event to one or more peripheral devices for provisioning through a respective user interface. The method includes receiving communication signals containing wager data on anonymized events, storing the wager data in the database, transmitting full event details to the peripheral device(s) after the betting window closes for rendering on respective user interfaces, and settling, or facilitating settling, wagers based on the revealed outcomes.

In some embodiments, the anonymizing process involves applying data masking techniques to team names and player identities. The anonymized data received by the peripheral device and presented on the respective user interface can include statistics such as a pitcher's ERA and a batter's batting average. The method can retrieve historical sports data using an indexing methodology based on market identifiers or event types and user interactions with the server through game play. Metadata related to historical events, including timestamps and regulatory information, is stored in the database, and real-time updates are transmitted to the peripheral device and presented through the user interface using technologies such as WebSockets or SSE. The method also allows users to select preferred market ordering strategies on their peripheral devices, such as ordering by timestamps or UUIDs.

In some embodiments, a non-transitory tangible computer-readable device stores instructions that, when executed by a computing device, cause it to retrieve historical sports data from a database, anonymize key details including team names and player identities, and transmit data and instruction signals to peripheral devices to present the anonymized data with relevant statistics to a user interface. The computing device further receives communication signals containing user wager data, stores wager data in the database, transmits to the peripheral device the full event details after the betting window closes, and settles, or facilitates settling, the wagers based on the revealed outcomes.

In some embodiments, the instructions on the computer-readable medium apply data masking techniques to anonymize team names and player identities and transmit the anonymized data with instructions to peripheral devices to provide statistics on user interfaces such as a pitcher's ERA and a batter’s batting average. The instructions, when executed by the computer device, can cause the computing device to retrieve historical sports data using an indexing methodology based on market identifiers or event types, and transmit data and instructions to peripheral devices to present real-time updates on user interfaces via WebSockets or SSE. The medium allows the system to provide live user interaction via peripheral devices and propagate updates to the user interface as new data is retrieved.

Additional features, advantages, and embodiments of the disclosure may be set forth or apparent from consideration of the detailed description and drawings. Moreover, it is to be understood that the foregoing summary of the disclosure and the following detailed description and drawings provide non-limiting examples that are intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain principles of the disclosure. No attempt is made to show structural details of the disclosure in more detail than may be necessary for a fundamental understanding of the disclosure and the various ways in which it can be practiced.

FIG. 1A illustrates an embodiment of a system for presenting anonymized historical sports markets, including implementing one or more market ordering strategies in a sports wagering system, according to some embodiments.

FIG. 1B illustrates another embodiment of the system for presenting anonymized historical sports markets, including implementing one or more market ordering strategies in a sports wagering system, according to some embodiments.

FIG. 2 illustrates a method for presenting anonymized historical sports markets, according to some embodiments.

FIG. 3 illustrates a method for implementing multiple market ordering strategies in a sports wagering system, according to some embodiments.

FIG. 4 illustrates an embodiment of a peripheral device for implementing multiple market ordering strategies in a sports wagering system, according to some embodiments.

FIGS. 5 to 11 depict embodiments of a user interface (UI) for a sports wagering system, according to some embodiments.

The present disclosure is further described in the detailed description that follows.

### DETAILED DESCRIPTION OF THE DISCLOSURE

The disclosure and the various features and advantageous details are explained more fully with reference to the non-limiting embodiments and examples that are described or illustrated in the accompanying drawings and detailed in the following description. It should be noted that the features illustrated in the drawings are not necessarily drawn to scale, and features of one embodiment can be employed with other embodiments, even if not explicitly stated. Descriptions of well-known components and processing techniques may be omitted so as to not unnecessarily obscure the embodiments of the disclosure. The examples are intended merely to facilitate an understanding of ways in which the disclosure can be practiced and to further enable those of skill in the art to practice the embodiments of the disclosure. Accordingly, the examples and embodiments should not be construed as limiting the scope of the disclosure. Moreover, it is noted that like reference numerals represent similar parts throughout the several views of the drawings.

State-of-the-art (SOTA) event-based wagering systems are primarily designed to support betting on live or upcoming events, where users have access to comprehensive information such as participant details, performance statistics, and contextual factors prior to placing wagers. While this model facilitates real-time engagement, it lacks flexibility for wagering based on historical events. In scenarios involving historical data, outcomes are frequently generated using random number generators (RNGs), which alters the regulatory classification from skill-based wagering to games of chance. This shift introduces additional compliance burdens and may restrict deployment in certain jurisdictions.

Additionally, existing systems often rely on static data displays and rigid market structures, offering limited personalization or adaptability. This inflexibility can diminish user engagement and constrain the system’s ability to accommodate varying regulatory requirements or user preferences. The instant disclosure provides a solution that overcomes these challenges and others. The disclosure provides a system equipped with an event-based computer prediction (EBCP) platform that includes secure, dynamic, and compliant interaction with historical event data and communication with peripheral devices, without dependence on, or use of any RNG-based outcome generators.

In various embodiments, the system includes hardware, firmware, software, and combinations thereof. In certain embodiments, the system may be implemented as instructions stored on a machine-readable medium and configured to be read and executed by one or more processors. A machine-readable medium can include any mechanism for storing or transmitting information in a form readable by a machine, such as, for example, a computing device. A machine-readable medium can include any one or more of a read only memory (ROM), a random-access memory (RAM), a magnetic disk storage media, an optical storage media, or other suitable media. Further, firmware, software, routines, and computer-executable instructions may be described herein as performing certain actions. However, it should be appreciated that such descriptions are merely for convenience and that such actions in fact result from computing devices executing the firmware, software, computer program routines, or computer-executable instructions.

It will be understood by those skilled in the art that the operations shown in the exemplary methods are not exhaustive and that other operations can be performed, including before, after, or between any of the illustrated operations. In some embodiments of the present disclosure, the operations can be performed in a different order and/or may vary.

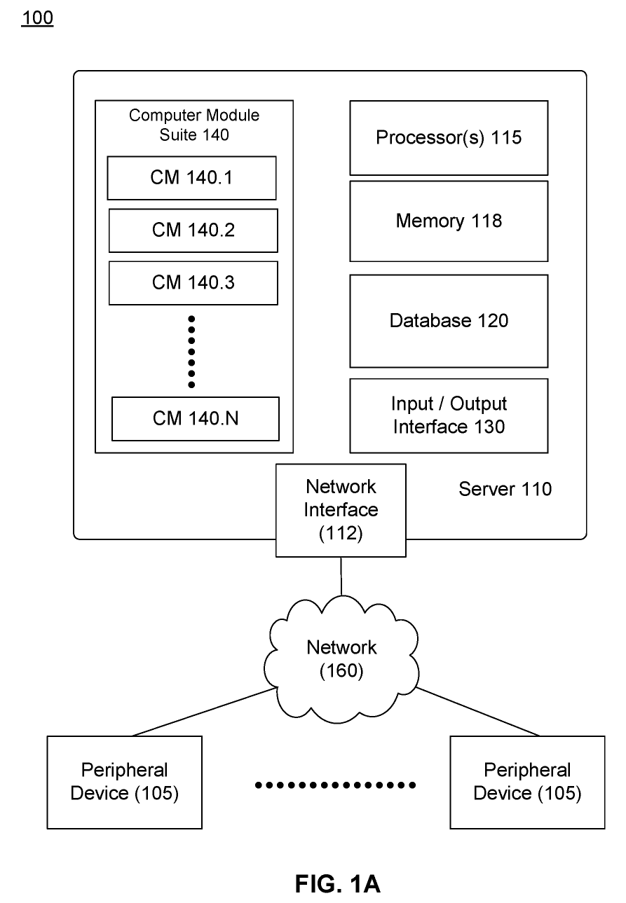

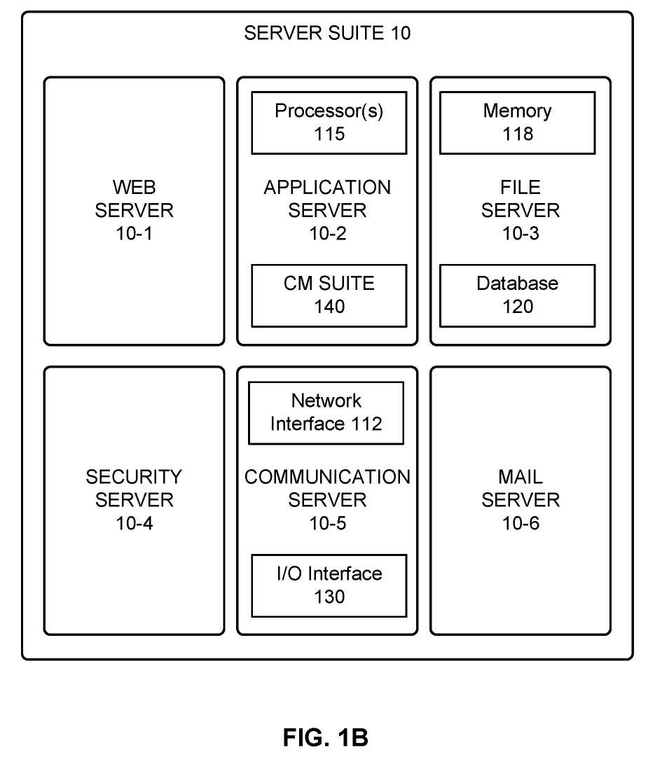

FIG. 1A illustrates a system 100 equipped with an event-based computer prediction (EBCP) platform configured to provide event-based predictive interaction with one or more peripheral devices 105. In various embodiments, the event-based predictive interaction can include sports wagering on historical sports markets. The system 100 is configured to communicate with each of the peripheral devices 105 and facilitate interaction by one or more of the peripheral devices 105 with event-based data, including, for example, enabling users to place bets via respective peripheral devices 105 on anonymized historical sports events, ensuring fairness and regulatory compliance anonymized historical sports events.

The system 100 includes the EBCP platform. In various embodiments, the system 100 can include a server 110 or a server suite 10 (shown in FIG. 1B), a network 160, and a plurality of peripheral devices 105. In an embodiment, the EBCP platform includes the server 110. In other embodiments, the EBCP platform is included in, or executable on, one or more computing devices. In certain embodiments, the EBCP platform includes the server suite 10 (shown in FIG. 1B), discussed below.

In various embodiments, the server 110 can include a network interface 112, one or more processors 115, a memory 118, a database 120, an input/output (I/O) interface 130, and a computer module suite 140. The I/O interface 130 can include one or more transmitters, receivers, or transceivers configured to transmit and/or receive electromagnetic signals, such as, for example, radio frequency (RF) signals. The computer module suite 140 can include one or more computer modules 140, each including, for example, a computing model (CM) 140.1 to 140.N, where N is a non-zero positive integer. The computing model 140 can include a supervised machine learning model or an unsupervised machine learning model.

The EBCP platform is configured to interact with each peripheral device 105 and manage user interactions, process wagers, and retrieve historical events data (for example, historical sports data) from the database 120. The EBCP platform is further configured to anonymize key details of each event, such as, for example, participant data and relevant categories or groups of participant data. In various embodiments, the EBCP platform is configured to anonymize key details of each sports event, such as teams and players involved, until a wagering market closes. For convenience, the system 100 and EBCP platform are referred to interchangeably in this specification, with the understanding that the system 100 comprises the EBCP platform, in addition to other computer resources and computing devices, including, in certain embodiments, the server 110 and peripheral devices 105; and, in at least one embodiment, also including the network 160.

The server 110 can be comprised of a single server, or alternatively a plurality of servers each configured to perform one or more distinct functions, or alternatively a plurality of servers configured to perform tasks in parallel. In some embodiments, the server 110 can transmit the full details of an event to the peripheral device(s) 105, such as, for example, after the market closes, allowing users via respective user interfaces to verify outcomes against third-party sources. This anonymization process can be implemented in various ways, such as masking identifiers, using generic placeholders, or obfuscating specific statistics sent to the peripheral devices 105 until a predetermined time. The peripheral devices 105 can include, for example, mobile devices, such as, for example, mobile phones, tablets, or other computing devices.

The memory 118 can include a read-only memory (ROM), a random-access memory (RAM), and a hard disk drive (HDD). In various embodiments, the ROM can include an erasable programmable read-only memory (EPROM) or an electrically erasable programmable read-only memory (EEPROM); the RAM can include a dynamic random-access memory (DRAM), a synchronous dynamic random-access memory (SDRAM), a static random-access memory (SRAM), a non-volatile random-access memory (NVRAM), or another high-speed RAM for caching data; and the HDD can include an enhanced integrated drive electronics (EIDE) drive, a serial advanced technology attachments (SATA) drive, a solid state drive (SSD), or any suitable hard disk drive, including for use with big data. The HDD can be configured for external use in a suitable chassis (not shown) and/or the HDD can be configured to connect to a bus (not shown) via a hard disk drive interface (not shown).

The memory 118, including computer-readable media, can be configured to provide nonvolatile storage of data, data structures, and computer-executable instructions (or computer program code). The memory 118 can accommodate the storage of any data in a suitable digital format. The memory 118 can include computing resources that can be used to execute aspects of the architecture included in the EBCP platform and system 100, including, for example, a program module, an application program, an application program interface (API), or program data.

In a non-limiting embodiment, the memory 118 can contain computer resources that are executable on the processor 115 to carry out the processes and functions disclosed herein. One or more of the computing resources can be cached in the RAM of the memory 118 as executable sections of computer program code or retrievable data. The memory 118 can include one or more removable storage components, such as, for example, a flash drive.

In various embodiments, the computing resources can include an API such as, for example, a web API, a simple object access protocol (SOAP) API, a remote procedure call (RPC) API, a representation state transfer (REST) API, or any other utility or service API.

The database 120 can be configured to store a large volume of historical events data, which can include, for example, past betting markets that were previously offered by regulated United States sportsbooks. The historical event data in the database 120 can replicate the original conditions of each event, including the same odds, when the market was live. In some embodiments, the database 120 stores metadata related to these markets, include time stamps, event context, and regulatory information for each event. The data structure within the database 120 can be optimized for quick retrieval and may use indexing techniques based on market identifiers, event types, or other relevant criteria.

In various embodiments, the database 120 is configured to be accessed by any one or more of the components in the system 100. The database 120 is configured to receive a query and, in response, retrieve specific data, data records or portions of data records based on the query, including historical event data. A data record can include, for example, a file or a log. The database 120 includes a database management system (DBMS) that can interact with the components in the system 100. The DBMS can include, for example, SQL, NoSQL, MySQL, Oracle, Postgress, Access, or Unix. The database 120 can include a relational database.

The I/O interface 130 can be configured to packetize/depacketize and transmit/receive information resources, including data and instructions, directly over one or more communication links, including communication links via the network interface 112, to the peripheral devices 105 to render (for example, in human-intelligible form) essential statistics on respective user interfaces to users, such as a pitcher's Earned Run Average (ERA) and a batter's batting average at the time the historical market was available. Rendering in human-intelligible form includes, for example, displaying and/or producing spoken the essential statistics and other renderable information.

The I/O interface 130 is configured to provide an engaging interaction experience, including receiving user wager data signals from the peripheral devices 105 to place wagers and transmit communication signals to the peripheral devices 105 to render outcomes efficiently on respective user interfaces. In some embodiments, the I/O interface 130 can include interactive elements, such as filters, search functions, and real-time updates, which can interact with the peripheral devices 105 to allow users to customize their wagering experience. Additionally, the I/O interface 130 can be adaptable to, or interact with, various platforms, such as web browsers, mobile applications, or dedicated terminals.

The computer module (CM) suite 140 can be configured to order and transmit market data or groups of markets (such as, for example, pitch markets in a static order, grouped by plate appearance) and instructions to peripheral devices 105 to present markets to users based on their interactions with the system 100, and more specifically the EBCP platform in the system 100. Unlike SOTA systems that require a Random Number Generator (RNG), the CM suite 140 can use a customer interaction-based ordering model to ensure that markets are surfaced in a consistent and fair manner. In various implementations, this approach can allow the system 100 to bypass RNG requirements while maintaining fairness and regulatory compliance under "Sports Wagering" rather than "iCasino" regulations.

In some embodiments, the CM suite 140 can employ various models for ordering markets. The CM suite 140 can include one or more computer resources or computing devices. For example, the CM suite 140 can include a computing model built and trained to rank markets based on historical data relevance, user preferences, or recent interactions with the system 100. The CM suite 140 can include one or more computing resources or computing devices configured to be adaptive, learning from user behavior to improve the relevance of market presentations over time.

In various embodiments, any one or more of the computing models CM 140.1 to 140.N (or “CM 140”) can include any one or more of a supervised machine learning platform, an unsupervised machine learning platform, a semi-supervised machine learning platform, and a reinforcement machine learning platform. The machine learning platform can include, for example, machine learning algorithms, K-nearest neighbor, Naive Bayes, decision trees, logistic model tree induction (LMT), NBTree classifier, case-based, linear regression, neural Turing machine (NTM), differential neural computer (DNC), support vector machines (SVM), k-means clustering, Q-learning, temporal difference (TD), deep adversarial networks, fuzzy logic, random forest, rough set, a deep learning neural network (DLNN), Word2vec deep neural network, convolutional architecture for fast feature embedding (CAFFE), artificial immune system (AIS), artificial neural network (ANN), convolutional neural network (CNN), deep convolutional neural network (DCNN), region-based convolutional neural network (R-CNN), you-only-look-once (YOLO), Mask-RCNN, deep convolutional encoder-decoder (DCED), recurrent neural network (RNN), or other suitable machine intelligence platform capable of supervised or unsupervised learning for learning and forecasting events, and for learning and predicting user behavior. In some embodiments, the CM 140 can include, for example, TensorFlow, PyTorch, Scikit-learn, XGBoost, LightGBM, CatBoost, Apache Spark MLlib, Keras.

Each of the computing models CM 140 can be configured by, for example, building a machine learning model or, in some instances, starting with an existing machine learning model, and training the model using annotated training datasets. In some embodiments, the CM 140 includes Random Forest and Logistic Regression models for analyzing and handling historical match data, and deep learning (for example, LSTM for time-series) for analyzing and handling player and/or team tracking data. The computing models can be validated using validation data as inputs for the models to generate predictions and comparing the values predicted by the models with the values in the validation datasets. The computing models can be configured for continuous learning, with parametric values fine-tuned during use to optimize prediction accuracy.

In some embodiments, the CM 140 can be configured for ordering markets based on the timestamp associated with each historical event. For instance, the last three digits of a timestamp might be used by a computing model as a key to order markets in a specific sequence, ensuring that the order remains consistent for each user session. In some embodiments, one or more computing models (CM 140) in the CM suite 140 can reorder these markets periodically based on user interaction metrics, such as the frequency of market selections or the duration of user engagement.

Another CM 140 can be configured to use unique identifiers, such as UUIDs (Universally Unique Identifiers), associated with each market. The CM 140 can be configured to sort markets based on the last four digits of the UUID, creating an order that appears random but is, in fact, deterministic and repeatable for regulatory compliance purposes.

The CM suite 140 can include one or more computing models configured to apply a dynamic weighting system, where markets are scored and ranked based on multiple factors. These factors can include, but are not limited to, the historical performance of the market, the odds offered at the time, the popularity of the event, and user-specific data such as past betting behavior. The weighting system can be configured to adjust the order of markets in real-time as more data becomes available or as user interactions evolve.

In some embodiments, the CM suite 140 can incorporate machine learning techniques to enhance the ordering process. For example, a machine learning model can be trained on historical user interaction data to predict which markets are likely to be of most interest to a specific user. The model can continuously refine its predictions by incorporating new data from ongoing user interactions, thus improving the relevance and fairness of the market order over time.

In some embodiments, one or more computing models in the CM suite 140 can be configured to leverage user interaction data to dynamically surface markets in a deterministic yet personalized manner. The CM suite 140 can be implemented across multiple algorithmic models that rank and present markets based on user behavior, timestamps, and historical relevance. This process can be achieved through the analysis of user interactions, where each interaction is logged and utilized to score available markets.

In some embodiments, this scoring approach can be configured to apply weights to specific factors including, but not limited to, the user’s past betting behavior, the popularity of the event, and historical performance of the market. For example, in one non-limiting embodiment, the CM 140 may rank a historical baseball market higher for a user who frequently interacts with baseball-related markets, while deprioritizing markets from other sports. The weights assigned to each factor can dynamically shift in response to new data from ongoing interactions, ensuring the most relevant and engaging markets are presented to the user.

The CM suite 140 can include a market ordering process that can employ various methodologies, including timestamp-based ordering, and UUID-based ordering. In the case of timestamp-based ordering, CM 140 can extract the last three digits of the event’s timestamp and sort markets accordingly, ensuring consistent yet pseudorandom presentation. Similarly, UUID-based ordering can be applied by extracting specific segments of a UUID, such as the last four digits, and using these to establish the market order. Both methodologies can ensure compliance with regulatory requirements by offering deterministic, auditable results that do not rely on RNGs.

In some embodiments, the CM suite 140 can incorporate one or more machine learning models and frameworks to continuously improve market recommendations based on user interaction data. Non-limiting examples of machine learning frameworks include TensorFlow, PyTorch, and Scikit-learn. These frameworks can be utilized to implement one or more CM 140 that predict which markets are likely to be of greatest interest to a particular user. For example, in an embodiment, the CM 140 can track which types of markets (for example, specific sports or event types) a user interacts with most frequently, using this data to suggest similar markets or events. As new interaction data is received, the CM 140 is updated, enabling the system 100 to fine-tune its predictions in real time.

Additionally, the CM 140 can be configured to re-order markets periodically based on metrics such as engagement duration, market selections, or the frequency of market interactions. For example, a market that receives a high level of engagement from the peripheral devices 105 may be moved up in the ordering sequence to ensure it is presented earlier in subsequent communication sessions with peripheral devices 105. This type of adaptive ranking enables a more personalized experience, continuously aligning the market presentations with user behavior.

Furthermore, the CM 140 can be configured to accommodate regulatory requirements by ensuring that the market ordering process is transparent and auditable. For example, the CM 140 can interact with the memory 118 in the server 110 to log each step of the market ordering process, allowing regulatory bodies to review and verify the fairness of the system. In some embodiments, the CM 140 can be configured to interact with the network interface 112 and/or I/O interface 130 to transmit a communication signal to a computing device (for example, a peripheral device 105) and provide a detailed report of the market ordering criteria and the specific factors considered for each user session.

In certain embodiments, the CM 140 can include configurable parameters that allow operators to adjust the market ordering strategy based on specific business goals or regulatory needs. For example, an operator might interact with the server 110 (for example, via the network interface 112 or I/O interface 130) to prioritize markets with higher historical engagement or adjust the weighting of certain factors to encourage diversity in market selection. These parameters can be adjusted in real-time or based on predefined schedules, providing flexibility in how markets are presented to users.

The CM 140 can be configured to provide a robust and adaptable framework for ordering and presenting historical sports markets to users, ensuring a fair, compliant, and engaging wagering experience. By leveraging customer interactions, historical data, and advanced algorithmic techniques, the system 100 can offer a unique approach to sports wagering that meets both user expectations and regulatory standards.

In an example use of system 100, a peripheral device 105 initiates a communication session and engages with the server 110 to place a wager on an anonymized historical sports market. Initially, the peripheral device 105 accesses a replay gaming platform via the server 110. Upon logging into the platform, the server 110, via the network interface 112 or I/O interface 130, transmits a communication signal containing data and instructions to present a range of available wagering markets on the peripheral device 105. These markets are anonymized by the system 100 to obscure specific details such as team names and player identities, ensuring the outcome is not prematurely revealed.

In some embodiments, the system 100 implements anonymization techniques to obscure key details of historical sports events in the transmitted data to the peripheral devices 105 until the market closes. These anonymization processes can be achieved through a combination of data masking, tokenization, and encryption by the CM suite 140 or processor 115. For example, in a non-limiting embodiment, team names, player identities, and event-specific metadata can be replaced with generic placeholders, such as, for example, “Team A” vs. “Team B”, ensuring that the outcome of the event remains unknown to the user prior to betting.

The anonymization process performed by the system 100 can be further enhanced with the system 110 configured to use data masking techniques, where sensitive event details are obfuscated by transforming the original values into masked values that maintain structure but lack informative content. For instance, the system 100 can mask individual player statistics in the transmitted data by replacing them with ranges or averages, thus providing enough information for an informed wager while preserving anonymity. This process can be reversed by the system 100 after the market closes, when the full details of the event are transmittable to the peripheral devices 105 to be revealed to the user.

In some embodiments, encryption mechanisms such as Advanced Encryption Standard (AES) can be applied by the system 100 to ensure that anonymized data remains secure during transmission and storage. For instance, the system 100 can apply AES-256 encryption to anonymized event data to ensure that even if any portion of the data accessed or intercepted in transit, it cannot be used to prematurely reveal market outcomes. When the market closes, the encrypted data can be decrypted and presented to the user with the full event details.

In various embodiments, the data can be transmitted by the system 100 and decrypted by the peripheral device 105 of the user. In some embodiments, the data can be decrypted by the system 100 and transmitted in decrypted form to the peripheral device 105. In certain embodiments, the system 100 is configured to apply a security protocol, such as, for example, the Transport Layer Security (TLS) 1.3 protocol for end-to-end encryption, thereby protecting against eavesdropping or tampering. In some embodiments, the system 100 is configured to apply an alternative, or additional, security protocol, such as at the Application Layer, including for example, message-level encryption (for example, using JSON Web Encryption or XML Encryption), digital signatures to ensure integrity and authenticity of data. The system 100 can be configured to implement secure channel protocols, such as, for example, ISO 20022, EMVCo Secure Channel Protocol (SCP), HSM-backed key exchange, Hardware Security Modules (HSMs), TLS 1.3 with mTLS, or EMV SCP,

After the system 100 establishes a communication session with a peripheral device 105, a user can navigate through the available markets rendered on the user interface of the peripheral device 105, and observe essential statistics associated with each event. In an embodiment, the system 100 is configured to transmit market rendering data and instructions to the peripheral device 105, which can then be executed by a processor (not shown) and/or web browser application in the peripheral device 105 to render on the user interface (for example, GUI) of the peripheral device 105 to render the available markets in an interactive manner that allows the user to navigate through the markets and observe essential statistics associated with each event.

For instance, in some embodiments, a user interface on a peripheral device 105 can receive data and instructions from the server 110 to, for a particular market, display via a graphic user interface (GUI) a pitcher's Earned Run Average (ERA) and a batter's batting average, relevant to the time when the market was historically available. These statistics are presented by system 100 to assist the user in making an informed decision, even though the specific teams and players involved remain anonymous at this stage.

The user selects a market of interest via the peripheral device 105, such as an MLB plate appearance, where displayed statistics on the user interface can suggest a competitive matchup. After reviewing the information provided, the user can interface with the user interface to place a wager. For instance, the user can interact with the user interface to enter a and confirm their bet, which is then packetized and transmitted to the system to be processed by the EBCP platform (for example, in the server 110) and stored in the memory 118 and, in some embodiments, recorded in the database 120. In some embodiments, the EBCP platform can be distributed on multiple servers 110, each which can be provided with a unique responsibility, such as, for example, processing bets, serving plate appearances, or the like.

Once the wagering window closes, the system 100 can transmit a communication signal to the peripheral devices 105 that reveals the full details of the selected market. This includes information such as the names of the teams and players involved, as well as the exact date and time when the event originally took place. With these details now visible, the user can verify the context of the wager they placed.

The system 100 is configured to retrieve the outcome of the historical event from the memory 118 and/or database 120 and determine whether the user’s wager was successful. For example, if the user bet on the batter achieving a hit and the historical record confirms the batter did indeed get a hit, the wager can be settled by the system 100 in the user’s favor. The winnings can then be credited by the system 100 to the user’s account stored in the database 120. To further ensure transparency, the system 100 allows the peripheral device 105 to access and facilitate verification by the user of the revealed event details against third-party sources. The access and verification can be facilitated between the system 100 and peripheral device 105 via the communication signals exchanged therebetween.

The user wagering process described in the example scenario, and performed by the system 100, can be facilitated and enabled by integrated technical components and methodologies within the system 100, including the EBCP platform or server 110. The EBCP platform, for example, operating on the server 110, can be configured to interact with each peripheral device 105 and manage user interactions, process wagers, and retrieve historical sports data. The EBCP platform, including server 110, can be implemented using a computing architecture configured for handling multiple concurrent user sessions and data transactions with peripheral devices 105.

FIG. 1B shows a server suite 10 included in an embodiment of the EBCP platform. In this embodiment, the server suite 10 includes a web server 10-1, an application server 10-2, a file server 10-3, a security server 10-4, a communication server 10-5, and a mail server 10-6. In an alternative embodiment, the server suite 10 includes the EBCP platform. In various embodiments, the web server 10-1 is configured to provide secure, scalable, and efficient access to web-based applications and services by the peripheral devices 105 (shown in FIG. 1A). The web server 10-1 is configured to service web applications in the system 100, including user dashboards on peripheral devices 105, allowing users to access processes described herein via browsers or APIs running on the peripheral devices 105. In various embodiments, the web server 10-1 is configured with HyperText Transfer Protocol Secure or HTTPS, which uses TLS (Transport Layer Security) encryption to ensure secure communication between peripheral devices 105 and the EBCP platform. The web server 10-1 includes RESTful or SOAP APIs for internal and external integrations.

In various embodiments, the application server 10-2 includes core computer resource assets of the EBCP platform, including the CM suite 140 (shown in FIG. 1A). The application server 10-2 can host core logic of these computer resource assets, including relating to order processing, authentication, wagering, event data handling and storage, and event forecasting. The application server 10-2 is configured to connect databases (including database 130 shown in FIG. 1A), APIs, message queues, and the peripheral devices 105, including to facilitate payment. The application server 10-2 is configured to handle a broad range of protocols, including, for example, HTTPS, RMI, SOAP, REST, and other communication protocols.

The file server 10-3 is configured, in an embodiment, to store, manage, and provision access to files for users and computer resources in the system 100. The file server 10-3 is configured to allow multiple peripheral devices 105 to simultaneously access files. In certain embodiments, the file server 10-3 includes the database 120 (show in FIG. 1A).

The security server 10-4 is configured, in various embodiments, is configured to enforce security policies, access controls, session timeouts, manage authentication and authorization of the peripheral devices 105, and protect the system 100 and data from unauthorized access or threats. In an embodiment, the security server 10-4 includes an activity directory of all peripheral devices 105 and associated users.

The communication server 10-5 is configured, in various embodiments, to manage and facilitate the various forms of digital communication between the EBCP platform and the peripheral devices 105. In some embodiments, the communication server 10-5 includes the network interface 112 and the I/O interface 130 (shown in FIG. 1A).

The mail server 10-6 is configured, in various embodiments, to handle all electronic messaging in the system 100, including sending/receiving emails to/from the peripheral devices 105 using, for example, Simple Mail Transfer Protocol (SMTP), Internet Message Access Protocol (IMAP), Post Office Protocol (POP).

In certain embodiments, the web server 10-1 can be configured to manage incoming HTTP/HTTPS requests from each peripheral device 105 and serve web pages or API responses, and the application server 10-2 can be configured to run logic required for anonymizing market data, processing wagers, and interacting with the database 120 (shown in FIG. 1A) and the file server 10-3. Additionally, the security server 10-4 can be configured to ensure secure access by the peripheral devices 105 to the EBCP platform using technologies such as, for example, OAuth 2.0, JSON Web Tokens (JWT), and secure password hashing algorithms like bcrypt.

In various embodiments, the EBCP platform can include additional computing resource assets (not shown), such as, for example, one or more switching and distribution layers, one or more routers, and one or more network switches. The switching and distribution layers can include a core layer and a distribution layer. The core layer can include one or more layers of switching devices (not shown) that connect the server suite 10 to the distribution layer. The distribution layer can include one or more layers of switching devices (not shown) that connect the core layer to the one or more routers, the one or more network switches, the communication server 10-5, or the security server 10-4. The switching and distribution layers can include one or more routers (not shown).

Referring to FIGS. 1A and 1B, in an embodiment the file server 10-3 includes the memory 118 and the database 120, which can be configured to store large volumes of historical sports data and manage complex queries efficiently. It can be implemented using a combination of relational and non-relational database technologies to balance consistency, scalability, and performance. In some embodiments, a relational database management system (RDBMS) might be utilized for structured data storage, including historical betting markets and user account information, while a NoSQL database could be used for storing large datasets and metadata related to historical events. The data structure within database 120 can be optimized for quick retrieval and may use indexing techniques based on market identifiers, event types, or other relevant criteria to ensure fast data access and processing.

In the embodiment, the communication server 10-5 (shown in FIG. 1B) includes the network interface and the I/O interface 130 (shown in FIG. 1A), which can provide an interactive and responsive experience for each peripheral device 105. It can be implemented using web development technologies and frameworks, ensuring compatibility across various devices, including smartphones, tablets, and computers. Front-end frameworks like React, Angular, or Vue.js may be used to provide dynamic and interactive user interfaces, and responsive design techniques such as CSS Flexbox and Grid, along with media queries, can enable the I/O interface 130 to interact with each peripheral device 105 and adapt to different screen sizes and devices. Real-time data updates can be pushed to each peripheral device 105 through technologies like WebSockets or Server-Sent Events (SSE), allowing users to receive the latest information without manual refreshing.

In the embodiment, the application server 10-2 includes the processor(s) 115 and the CM suite 140, which is configured for ordering and presenting markets based on user interactions. It includes various computer modules, including models, algorithms, and methodologies, to ensure fairness and regulatory compliance without relying on random number generators. The interaction-based ordering CM 140 can include machine learning models configured to analyze user behavior and preferences, including, for example, TensorFlow or PyTorch. The CM 140 can consider factors such as user engagement, past betting behavior, and market popularity to determine the order in which markets are presented. For deterministic ordering, the CM 140 might use timestamp and UUID-based methods, where the last digits of timestamps or UUIDs are utilized to generate an order that is reproducible and fair. This can include hashing functions and modular arithmetic to create consistent order keys.

The CM 140 can implement a dynamic weighting system that assigns scores to different markets based on multiple factors, including historical performance, odds, and user preferences. This system 100 can be configured to adjust the order of markets in real-time as more data becomes available or as user interactions evolve, ensuring a personalized and fair experience. In some embodiments, the CM 140 can incorporate machine learning models trained on historical user interaction data to predict which markets are most likely to interest a specific user. These models can continuously refine their predictions by incorporating new data from ongoing user interactions, enhancing the relevance and fairness of the market order over time.

Security and compliance are essential aspects of the wagering process, with data encryption being applied both at rest and in transit using standards such as AES-256 and TLS/SSL. Detailed audit trails and logging mechanisms are in place to record all transactions and algorithm decisions, stored in an immutable format for regulatory review. Technologies like the ELK Stack (Elasticsearch, Logstash, Kibana) may be used to manage these logs effectively. The system 100 can be configured to meet regulatory requirements specific to "Sports Wagering" as opposed to "iCasino," with automated compliance checks and regular audits ensuring ongoing adherence to relevant laws and guidelines.

To maintain user trust, the system 100 provides mechanisms for transparency and verification. Once the market closes, the database 120 (or the memory 118) can be accessed to fetch and transmit data and instructions to the peripheral devices 105 to display the full details of the historical event, including teams, players, and the exact date and time of the event. This information can be transmitted to the peripheral device 105 and presented to the user through the respective user interface, allowing for verification against third-party sources if desired. In some embodiments, the system 100 can include APIs that fetch external data from external data sources and present it alongside the platform data on the peripheral devices 105, and/or that expose market information for other systems to query, facilitating easy cross-verification by users.

The system 100 can be configured with a scalable architecture for storing and retrieving historical sports data. The memory 118 and the database 120 can be configured to handle large volumes of data, including event metadata, betting odds, timestamps, and user interaction logs. In some embodiments, the database 120 can be implemented using a combination of relational and non-relational database technologies. Non-limiting examples include relational database management systems (RDBMS) such as MySQL or PostgreSQL for structured data, and NoSQL databases such as MongoDB or Cassandra for storing large datasets and metadata, or combinations of multiple such systems.

The structure of the database 120 can be optimized for quick retrieval, employing indexing techniques to ensure efficient access to historical data. In some embodiments, the system 100 can use the memory 118 to skip database access and serve the data straight from the memory 118. For example, in an embodiment, indexing can be applied to market identifiers, event types, or timestamps, allowing the system 100 to quickly fetch relevant data when a user requests a market. Additionally, metadata associated with the historical events such as event context, odds, and regulatory information, for example, can be stored alongside the event data to facilitate transparency and auditability.

In some embodiments, the database 120 can be partitioned or sharded to accommodate horizontal scaling, ensuring that the system 100 can handle a high volume of concurrent user queries without sacrificing performance. Sharding enables the distribution of data across multiple database instances, allowing for increased throughput and reduced latency during peak usage periods. Additionally, caching mechanisms, such as Redis or Memcached, can be implemented to store frequently accessed data in memory, further improving response times and reducing the load on the primary database.

Referring to FIG. 1B, the system 100 is configured with a web server 10-1 that includes, for example, NGINX or HAProxy for load balancing and to distribute incoming traffic across multiple servers, ensuring high availability and performance. In an embodiment, the Horizontal scaling allows the addition of more server instances to handle increased load, managed through container orchestration platforms such as Kubernetes or Docker Swarm. Caching mechanisms, potentially implemented using Redis or Memcached, reduce database load and improve response times, further enhancing system performance.

In some embodiments, system 100 can incorporate real-time data update technologies that allow the user interface on the peripheral device 105 to refresh with the latest market information from the server 110 (or server suite 10, in FIG. 1B) without manual intervention. This can be achieved using WebSockets or Server-Sent Events (SSE), for example, configured to provide real-time updates by maintaining an open connection between the server and the peripheral device 105. For example, when new betting markets are surfaced or existing markets are updated, the system 100 pushes the relevant data directly to the peripheral device 105, ensuring that the displayed markets reflect the most current information.

The system 100 can also implement horizontal scaling, wherein additional server instances are automatically provisioned in response to increased demand. This scaling can be managed through container orchestration platforms, such as Kubernetes or Docker Swarm, which allow the system to dynamically allocate resources and scale based on real-time traffic patterns. By deploying multiple instances of server 110 (or server suite 10, in FIG. 1B) and the database 120, the system 100 can handle large-scale operations while maintaining low latency and high availability.

The system 100 can be configured to ensure fairness providing mechanisms for post-market transparency and verification. For example, once a wagering market closes, the system 100 can retrieve full details of the historical sports event from the database 120 and transmit data and instructions to the peripheral devices 105 to present them to the users through the user interfaces. This includes revealing team names, player identities, and the exact date and time of the event. Users can then verify the outcome of their wager by cross-referencing the revealed data with trusted third-party sources on their respective peripheral devices 105, such as public sports databases or media outlets.

In some embodiments, the system 100 can be configured to restrict access to certain event results, such as a plate appearance in a baseball game, until the corresponding wagering market has closed. This ensures that users cannot prematurely access results before the opportunity to place a wager has ended, maintaining the integrity of the wagering process. In a non-limiting example, access to specific game outcomes can be delayed until the market is officially closed, and the system can enforce this through time-based restrictions or conditions tied to the closing of the wagering market. This limitation can prevent users from gaining an unfair advantage by viewing results before placing wagers, ensuring fairness and compliance with regulatory requirements.

In some embodiments, the system may provide APIs or hyperlinks that allow the peripheral devices 105 to directly access external verification sources. For example, after a market closes, the user interface may display a “Verify with Third-Party Source” button, which links to a publicly accessible sports database (e.g., ESPN, MLB.com, or the like) containing the original event details. This layer of transparency ensures that users can independently verify the accuracy of the system’s results, fostering greater trust in the platform.

To improve user experience, the system 100 can incorporate personalized recommendations based on user behavior and preferences determined by the CM suite 140 for each user, which can include using collaborative filtering and content-based filtering algorithms. Interactive visualizations of statistics and outcomes are generated by the system 100 and implemented, for example, using graphical libraries like D3.js or Chart.js, to provide users with clear and engaging representations of their wagering activities. These technical aspects collectively enable the EBCP platform to implement replay gaming to deliver a secure, fair, and engaging wagering experience, meeting both user expectations and regulatory standards.

This exemplary embodiment demonstrates how the system 100 can provide an engaging wagering experience for the user by leveraging anonymized historical sports data, a user interaction-based CM suite 140, and post-market transparency. The EBCP platform thus allows for sports wagering at any time, independent of current sports schedules, while maintaining fairness and regulatory compliance.

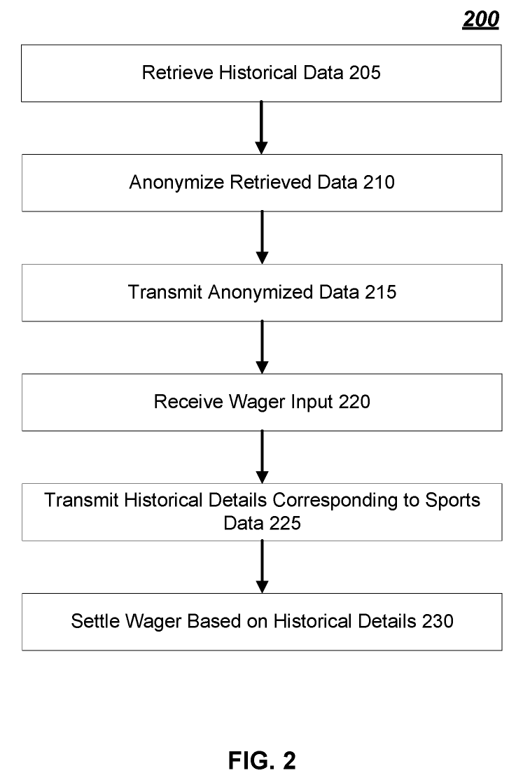

FIG. 2 shows a flow diagram of a process 200 for facilitating sports wagering on anonymized historical sports events that can be performed by the EBCP platform. The process 200 is designed to be carried out by the EBCP platform and support fairness, transparency, and regulatory compliance while maintaining user engagement. Each operational step in process 200 can be carried out by the processor 115, which is configured to efficiently handle anonymized historical data, secure wagering, and post-market verification.

Referring to FIG. 2, at operation 205, the process begins with the processor 115 retrieving historical sports data from the database 120. The data retrieved is specific to a particular sports event, such as an MLB plate appearance, and can include multiple types of data points, such as player statistics, event context, and betting odds. In some embodiments, the database 120 is structured to store a vast collection of historical sports data, which can be indexed by various parameters, such as event type, market identifier, or timestamps. For efficient retrieval, the database may employ techniques such as indexing, sharding, or caching to ensure low-latency access to the relevant data. For instance, in a non-limiting example, if a user selects an MLB market, the system retrieves data specific to that event, such as a pitcher’s ERA, the batter’s historical performance, and the betting odds at the time the market was originally live.

At operation 210, the processor 115 proceeds to anonymize key details of the retrieved data. The anonymization process can prevent users from deducing the outcome of the historical event before placing their bets. In some embodiments, this anonymization is accomplished using a combination of data masking and obfuscation techniques. For example, team names and player identities may be replaced with placeholders such as "Team A" or "Player X," allowing users to access relevant statistics without revealing specific event details. In some embodiments, the processor’s data masking can extend to player statistics, providing generalized ranges instead of exact numbers, while still enabling users to make informed wagers. Additionally, the processor 115 (or security server 10-4, sown in FIG. 1B) can encrypt the data prior to transmission using, for example, AES-256, to secure the anonymized data during transmission and storage, ensuring the integrity of the data remains uncompromised until the market closes.

At operation 215, the anonymized data is transmitted by the network interface 112 or I/O interface 130 to the peripheral device 105 to be presented on the user interface. The user interface in each peripheral device 105 can be configured to, based on the data and instructions received from the EBCP platform, display key statistics and other essential data points relevant to the event, such as the pitcher's ERA and the batter's batting average. These statistics allow users to make informed decisions when placing their bets, even though the underlying teams, players, and event specifics are not yet revealed. In some embodiments, user interface may, based on the received data and instructions, provide additional interactive elements, such as filters or search functions, that allow users to customize their viewing experience based on personal preferences. The user interface can be optimized to work across various platforms, including mobile devices, tablets, and desktop browsers. In some embodiments, the processor 115 can use WebSockets, Server-Sent Events (SSE), or other suitable protocols, to push real-time updates to the peripheral devices 105, ensuring that users are presented with the most current data without needing to manually refresh the interface.

At operation 220, the processor 115 receives user wager data from the peripheral devices 105 via the network interface 112 or I/O interface 130 after users place their wagers on the anonymized event through respective user interfaces. In some embodiments, the system 100 can be configured to process a wager separate from processes carried out to process the plate appearances and markets. Once a wager is placed and the user wager data received, the system 100 stores the wager data in the memory 118 and records the wager data, including bet, in the database 120, associating it with the anonymized event data. In some embodiments, the wagering process is configured to be efficient and engaging, with minimal delay between placing the wager and confirming it in the system 100 by storing the data in the memory 118, thereby minimizing lag attributed to retrieving data from the database 120. The user interface may include visual cues such as progress bars or notifications to inform users when their wagers have been successfully recorded. During this operation, processor 115 handles user authentication, verifying that each wager is placed by an authorized user. Technologies such as OAuth 2.0, JSON Web Tokens (JWT), and secure password hashing algorithms (e.g., bcrypt) may be employed to ensure that only authorized users can participate in the wagering process.

At operation 225, once the betting window has closed, the processor 115 transmits a communication signal via the network interface 112 or I/O interface to the peripheral device 105. The communication signal contains data and instructions that reveal the full details of the historical event. This includes previously anonymized information such as team names, player identities, and the exact date and time of the event. The revelation and display of these details on the user interface ensures that users can fully understand the context of the wager they placed. In some embodiments, the processor 115 retrieves this information from the memory 118 or the database 120 and transmits it to the peripheral device 105 to present it to the user through the user interface. This revelation may be done in stages, allowing users to verify individual aspects of the event as needed. For example, the team names and players may be revealed first, followed by detailed statistics and the outcome of the event. Additionally, the system 100 may provide users with dashboard tools (for example, via the web server 10-1) to verify the outcomes against third-party sources, ensuring transparency and trust in the system. This could include providing external links or APIs to trusted sports databases where users can independently verify the event results.

At operation 230, the processor 115 settles, or facilitates settling, the wagers based on the revealed event details. This step involves determining whether the user's wager was successful based on the outcome of the historical event. For example, if a user bet on a batter to achieve a hit, and the revealed event confirms the batter did indeed get a hit, the wager is settled in favor of the user. In some embodiments, the settlement process may involve transferring winnings to the user’s account, which can be handled automatically by the processor 115. The system 100 can generate and store an audit trail of each wager and its outcome, ensuring that all transactions are securely logged for regulatory review if necessary. The system 100 (for example, security server 10-4, shown in FIG. 1B) can employ secure transaction protocols, such as TLS/SSL encryption, to ensure that all financial transactions related to settling the wager are protected. Once the settlement is complete, the results are displayed to the user via the user interface on the peripheral device 105. In some embodiments, peripheral devices 105 may receive a summary of the user’s betting history, including both successful and unsuccessful wagers, allowing them to track their performance over time.

In various embodiments, the process 200 is configured to provide users, when implemented by the system 100, with a secure, fair, and engaging experience when wagering on anonymized historical sports events. By incorporating multiple layers of data retrieval, anonymization, and user interaction, the system 100 offers a unique approach to sports wagering that maintains compliance with regulatory standards while enhancing user trust and engagement.

Referring to FIGS. 1A and 1B, the processor 115 can be configured to interface with the CM suite 140, including each of the computing models CM 140.1 to CM 140.N, each implementing a different market ordering strategy. In some embodiment, incorporating multiple CMs 140, each configured to implement a distinct market ordering strategy, enables the system 100 to address different regulatory environments, user preferences, and engagement metrics, ensuring fairness and compliance across various use cases.

The server 110 (or server suite 10, shown in FIG. 1B) can operate as a central hub for managing interactions between the CMs 140.1 to 140.N, the database 120, and the peripheral devices 105. In some embodiments, the processor 115 dynamically selects and activates an applicable CM based on a set of predefined rules. These rules can be established according to various factors, including user preferences, regulatory requirements, and system performance metrics. For example, the processor 115 can analyze stored user preferences and interaction history to determine which CM 140 is most suitable for presenting markets to a specific user. A user with a history of interacting with timestamp-ordered markets may have, for example, the CM 140.1 prioritized for their session. Additionally, the processor 115 can evaluate the regulatory requirements for each jurisdiction and select the corresponding CM 140.1 to 140.N to ensure compliance. Some jurisdictions may require specific market ordering methodologies, and the processor 115 can select the appropriate CM 140 to meet local regulations. For instance, a market that requires a deterministic approach for auditability might utilize UUID-based ordering through the CM 140.2.

In some embodiments, the processor 115 can monitor system performance in real time and switch between the CMs in the CM suite 140 based on system load or other operational constraints. For example, if one CM becomes resource-intensive, the system can dynamically switch to a less resource-consuming CM to ensure optimal performance without compromising the user experience. In another example, the CM 140.1 can be more computationally demanding due to the volume of historical market data, whereas the CM 140.2, which reorders markets based on user interaction metrics, might be more efficient under certain conditions.

In some embodiments, the selection of the applicable CM may also be influenced by external triggers, such as the time of day or the nature of the sports event being bet on. For example, certain algorithm modules may be better suited for high-traffic periods, while others may be optimal for handling specific types of historical sports data. The dynamic selection process managed by the processor 115 ensures that the most suitable market ordering strategy is always in place, providing an engaging and fair experience for users while adhering to regulatory requirements. The processor 115 can interface with the database 120 to retrieve the necessary historical sports data and associated configurations for each CM, ensuring that the relevant data is accessible regardless of the market ordering strategy in use.

In some embodiments, the database 120 is configured to store historical sports data together with the associated metadata and model configurations and that are necessary for the operation of each CM 140.1 to 140.N. This structure allows the system 100 to dynamically retrieve the relevant data when switching between CMs, ensuring continuity and consistency in market presentation. For example, if a user is switched from an interaction-based CM to a timestamp-based one, the system 100 can retrieve the applicable data and market configurations without any noticeable interruption to the user experience.

The I/O interface 130 can be configured to transmit data and instructions to the peripheral devices 105 that are executable by the processors in the devices for rendering and presenting the selected market ordering strategy by a display or speaker to the user. In some embodiments, the data and instructions can be generated and transmitted to the peripheral device 105 to be adaptable, causing the peripheral device 105 to display different market presentations based on the CM selected by the processor 115. For example, when the CM 140.1 is in use, markets or groups of markets can be displayed in a sequence determined by the last three digits of a timestamp, creating a pseudorandom but deterministic order. When the CM 140.2 is selected by the processor 115 and operated, markets can be presented according to the last four digits of a UUID associated with the market data. The CM 140.3, which reorders markets at specific points in time based on customer interaction data, may surface markets based on engagement metrics such as the frequency of user selections or the duration of user interaction with specific types of markets. In another example, the CM 140.1 may order markets based on the last three digits of a timestamp, while the CM 140.2 may use the last four digits of a UUID associated with the market data. The CM 140.3 may reorder markets at specific points in time based on customer interaction data.

The I/O interface 130 can be configured to interact with each peripheral device 105 to allow the user to manually select their preferred market ordering strategy from a list of available options. In some embodiments, the system 100 provides recommendations based on past behavior, but the user can override these recommendations to customize their experience. For example, the user may prefer markets ordered by timestamp for one session and by user interaction metrics for another. The system’s flexibility ensures that user remains in control of their betting experience while still adhering to fairness and regulatory compliance.

In some embodiments, the system 100 may include feedback loops, where user selections and engagement metrics are fed back into the CM suite 140 to update parametric values in the CMs and improve future market presentations. However, despite implementing user interface changes in response to these feedback loops, the system 100 will not modify the order of specific events, such as, for example, the sequence of at-bats in a game, based on user interaction with the interface. This ensures that critical elements of the wagering process, like the order of at-bats, remain consistent and are not influenced by user engagement. Over time, the CMs 140.1 to 140.N can learn from user behavior and adjust to other market ordering strategies to better align with user preferences. This adaptive approach ensures that the system 100 remains responsive to changes in user behavior, offering a personalized and engaging experience while ensuring that the system 100 can satisfy technical requirements for regulatory compliance.

The database 120 can be configured to store historical sports data and the associated computing model or model configurations for each market ordering strategy. The system 100 can dynamically switch between different CMs based on user preferences or regulatory requirements.

The I/O interface 130 exchanges data and instructions with the peripheral devices 105 to present the appropriate market ordering strategy to users based on their selections or system recommendations. The I/O interface 130 can interact with the peripheral devices 105 to allow users to experience different market presentations while ensuring fairness and compliance with the relevant regulations.

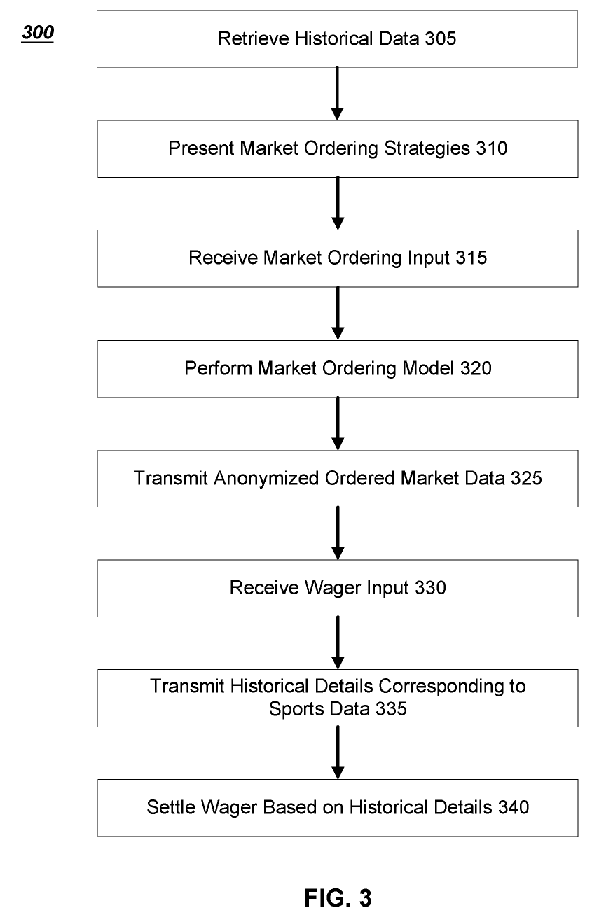

FIG. 3 illustrates a flow diagram of a process 300 for implementing multiple market ordering strategies in a sports wagering environment that can be carried out by the EBCP platform. The process 300 can be executed with participation of multiple CMs, as described in the embodiments above. The process 300 is configured to allow flexibility in how the EBCP platform presents historical sports markets to users, including having the EBCP platform select and apply different market ordering strategies based on user preferences, regulatory requirements, or other factors.

At operation 305, the process begins with processor 115 retrieving historical sports data from the database 120. The retrieved data corresponds to a specific historical sports event, such as an MLB plate appearance, and includes data points such as player statistics, betting odds, and event context. Simultaneously, the processor 115 identifies the available market ordering strategies from the CMs 140.1, 140.2, and 140.3. In some embodiments, the database 120 stores historical sports data together with the associated metadata and configurations for each CM, allowing the system to dynamically retrieve relevant data and order markets based on the selected CM. The CMs may use different criteria, such as timestamps, UUID digits, or customer interaction metrics, to determine the order in which markets are presented. The retrieval process ensures that all relevant data and configurations are available for the next step in the method.

At operation 310, the processor 115, interacting with the CM suite 140 and the I/O interface 130, transmits the instructions and data to the peripheral devices 105 to present the available market ordering strategies to the user via respective user interfaces. The user interfaces of the peripheral devices 105 can be configured, based on the data and instructions received from the server 110 (or server suite 10), to display the different ordering options in a way that is intuitive and easy to navigate. For example, a user may be presented with a selection screen that provides descriptions of each market ordering method. The user can choose from options such as timestamp-based ordering, UUID-based ordering, or an interaction-based CM that adapts based on past user behavior. For example, if the user has previously interacted with timestamp-ordered markets, the system may suggest that the user continue with the timestamp-based strategy. User interface may employ responsive design techniques, based on the data and instructions received from the server 110, to ensure that the selection process is intuitive and engaging across different platforms, including mobile devices, tablets, and desktops. At operation 315, the user may select their preferred market ordering strategy, the selection transmitted to the server 110 (or server suite 10).

At operation 320, once the user has selected their preferred market ordering strategy and the server 110 receives the selection data, the selected CM (for example, 140.1, 140.2, … 140.N) orders the markets accordingly. Each CM 140 implements a different strategy based on predefined criteria. For example, if the CM 140.1 is selected based on the user selection, which orders markets based on timestamps, the markets may be ordered according to the last three digits of the event’s timestamp. Similarly, if the CM 140.2 is selected based on the user selection, which orders markets based on UUID digits, the system 100 may extract the last four digits of the UUID associated with each historical event to establish the order. The CM 140.3 may use a user interaction-based ordering method, which adapts to the user’s betting history and preferences by prioritizing markets that the user has engaged with most frequently in the past. The group of markets or markets can be ordered according to user request completion sequencing. For instance, the order of presentation of the markets or groups of markets can depend on concurrent users completing their at-bats, which will determine the order the completed at-bats are placed in the queue. In some embodiments, the CMs can be further configured to adapt dynamically based on real-time user interactions, ensuring that the markets presented are always relevant and engaging for the user.

At operation 325, the processor 115, via the I/O interface 30 or network interface 112, transmits data and instructions to the peripheral devices 105 and the ordered markets are rendered and presented by the peripheral devices 105 to the users via respective user interfaces. The presentation of the markets can be tailored to the user’s selection, ensuring that the markets appear in the desired order, whether it be timestamp-based, UUID-based, or interaction-based. The system 100 can ensure that the anonymized data for each market is transmitted to, and displayed by, each target peripheral device 105, providing the associated user with essential statistics such as a pitcher’s ERA or a batter’s batting average, while masking key details like team names and player identities. This anonymized presentation ensures that users can make informed bets without having access to the full details of the historical event until the market closes. In some embodiments, the user interface is configured to, based on data and instructions received from the system 100, update in real-time, with new markets being pushed to the user’s peripheral device 105 as they become available, using technologies like WebSockets or Server-Sent Events (SSE).

At operation 330, after the user inputs a wager in the peripheral device 105 for the anonymized event through the user interface on the user’s peripheral device 105, the system 100 receives the user wager data and processes the bet and records it in the database 120. In some embodiments, the system 100 also stores the wager data in the memory 118 for quick access and retrieval. The wager is stored alongside the specific ordering strategy that was used to present the market, ensuring that the system 100 can track and audit the entire betting process. In some embodiments, the system 100 also handles user authentication during this process to ensure that only authorized users can place bets. Security protocols, such as, for example, OAuth 2.0, JSON Web Tokens (JWT), and encryption algorithms like AES-256 can be applied to ensure that the betting process is secure. Additionally, the system 100 is configured to generate an audit trail for each bet, recording the market details, user actions, and the selected ordering CM 140 to ensure compliance with regulatory requirements.

At operation 335, once the betting window has closed, the system 100 exchanges data and instructions with the peripheral devices 105 to reveal the full details of the historical event, including team names, player identities, and the exact date and time of the event. In an embodiment, this process can be included in operation 225 (shown in FIG. 2), where anonymized data is revealed after the betting window closes. In this embodiment, the market ordering strategy used in the operation can be logged and presented to the user as part of the betting history. This ensures transparency, allowing the user to understand how the markets were ordered and how their bets were processed.

The system 100 then settles, or facilitates settling, the wagers at operation 340 based on the revealed event details. For example, if the user placed a bet on the outcome of an MLB plate appearance, and the revealed event confirms that the batter hit a home run, the system 100 settles the wager in favor of the user. The settlement process can include transferring winnings to the user’s account, which is recorded in the database 120. The system 100 may also generate a detailed report of the betting session, including the market ordering strategy, bet outcomes, and any relevant user actions, and store the report in the database 120 and, where applicable, transmit the report to a predetermined computer device for reporting purposes.

In some embodiments, the system 100 may further provide the user with the option to verify the results of the wager using third-party sources. This verification process can be facilitated by providing external links or APIs that allow the user to access the information via the peripheral device 105 and cross-check the event details against public sports databases. This level of transparency ensures that users have confidence in the system 100 and can trust that the results are accurate and fair. Additionally, the system’s audit trail, which logs each market ordering strategy and bet outcome, can be reviewed by regulatory authorities to ensure compliance with sports wagering laws and standards.

By offering multiple market ordering strategies through the CMs 140.1, 140.2, … 140.N, the system 100, performing the operations 305 to 340, provides a flexible and adaptive framework for presenting historical sports markets. This flexibility ensures that the system 100 can cater to different user preferences, regulatory requirements, and operational needs, creating a dynamic and personalized wagering experience for users. At the same time, the system 100 maintains the transparency and fairness necessary to comply with the stringent regulations governing sports wagering. The process 300 allows the EBCP platform to adapt to user preferences and regulatory environments while ensuring that all bets are processed securely, transparently, and efficiently.

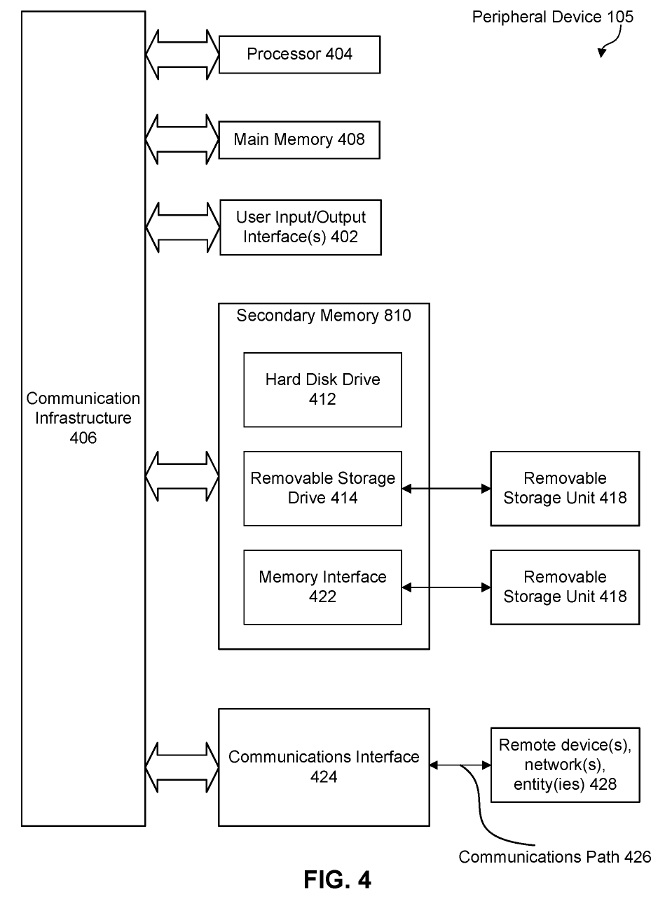

FIG. 4 illustrates a non-limiting embodiment of the peripheral device 105, constructed according to the principles of the disclosure. The peripheral device 105 includes one or more input/output interfaces 402, a processor 404, a communication infrastructure 406, a main memory 408, a secondary memory 810, and a communication interface 424. The secondary memory 810 includes a hard disk drive 412, a removable storage drive 414, and a memory interface 422. The peripheral device 105 can include one or more removable storage units 418, which can be configured to communicate with the secondary memory 810 via one or more communication links. The communication interface 424 can be configured to communicate with one or more communicating devices, networks, or entities 428 via one or more communication links 426.

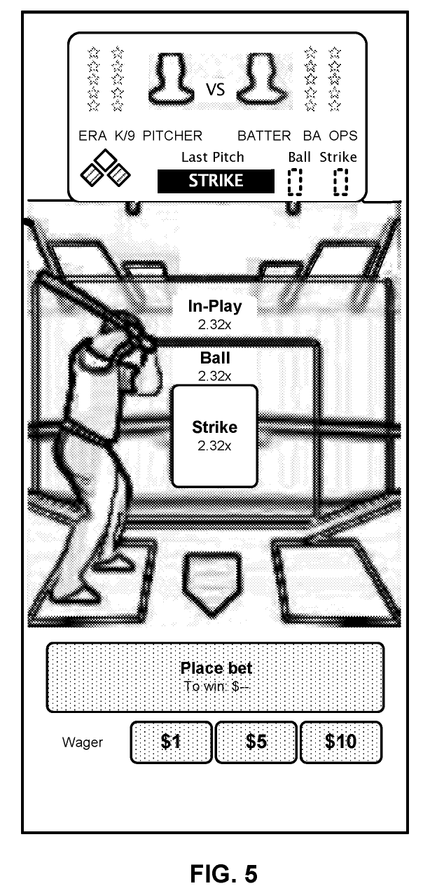

FIGS. 5 to 11 illustrate non-limiting embodiments of a user interface (UI) that can be rendered and presented on a display device (not shown) of the peripheral device 105, according to the principles of the disclosure. In these embodiments, transmitted data and instructions can be received from the system 100 via the communication interface 424 (shown in FIG. 4), processed by the processor 404, and presented via the I/O interface 402 to the user for anonymized historical sports markets, including according to the operations in the processes 200 (shown in FIG. 2) and 300 (shown in FIG. 3), according to some embodiments.

The user interface is configured to interact with and to enable users to place wagers on specific outcomes within a historical sports event, such as the result of the next pitch in a baseball game. The system 100 anonymizes certain aspects of the event, such as player names and team identities, while presenting relevant statistics to inform the user’s decision-making process. The UI can be generated by the processor 404 (shown in FIG. 4) of the peripheral device 105 based on data and instructions received from the system 100 (shown in FIGS. 1A and 1B) and displayed on a display device (not shown) on the peripheral device 105.

In the embodiment of FIG. 5, the user interface is rendered and presented, by the processor 404, in an active state where the user can interact with the UI and place a wager on the next pitch. The UI displays key statistics about both the pitcher and the batter, including the pitcher’s Earned Run Average (ERA) and strikeouts per 9 innings (K/9), and the batter’s Batting Average (BA) and On-base Plus Slugging (OPS). These statistics are anonymized to the extent that the specific players’ identities are not revealed, allowing users to make informed wagers while maintaining fairness in the market by obscuring the actual outcome of the historical event. The UI also displays betting options such as "Ball," "Strike," and "In Play," with associated multipliers that indicate the potential winnings for each option. The user can choose preset betting amounts (e.g., $1, $5, $10), which streamlines the wagering process by allowing users to quickly select a wager.

At this stage, the system 100 can follow the operations of the process 200 (shown in FIG. 2), where the processor 115 (shown in FIGS. 1A and 1B) retrieves historical sports data from the memory 118 or the database 120 (Action 205, FIG. 2), anonymizes key details (Action 210, FIG. 2), and transmits the anonymized data (Action 215, FIG. 2) to the peripheral device 105, which then renders and presents the anonymized data via the user interface. The system 100 can leverage data masking techniques to ensure the integrity of the historical event remains intact until the betting window closes. In various embodiments, the peripheral device 105 receives data and instructions for the user interface to present only the necessary statistics, such as the pitcher’s ERA and the batter’s BA, allowing the user to make an informed wager on anonymized data. This ensures that the market is fair and compliant with regulatory requirements, as users cannot predict the outcome based on the anonymized data alone.

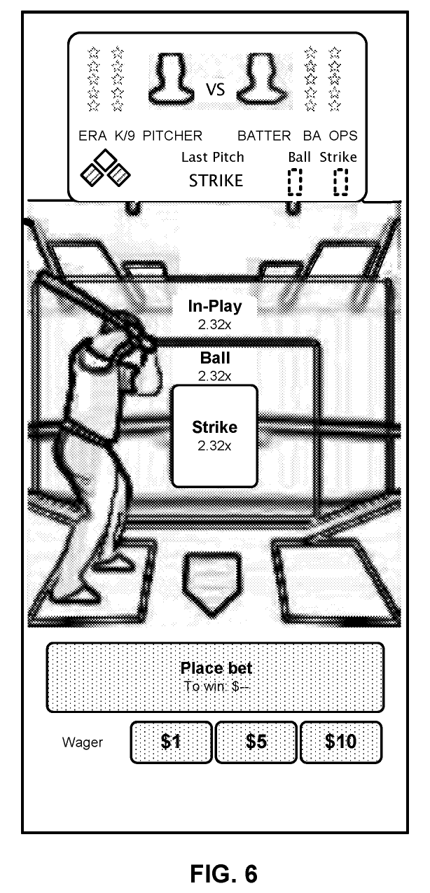

In the embodiment of FIG. 6, the UI reflects the user’s selection on the peripheral device 105 and highlights the wager placed on the next pitch. Once the user selects a betting option (e.g., a "Strike"), the UI shows a visual confirmation of the bet, including the amount wagered and the potential payout based on the multiplier associated with the selected option. At this point, the system 100 records the wager in the database 120 (shown in FIGS. 1A and 1B), associating it with the anonymized event, in line with the process 200 (shown in FIG. 2). The system 100 awaits the closing of the betting window before revealing any further details about the event.

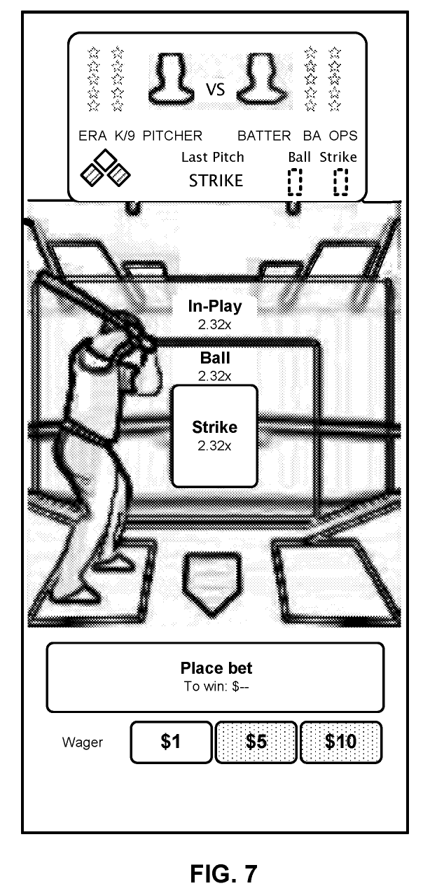

In the embodiment of FIG. 7, the UI displays the confirmation message "Bet Placed!" indicating that the user’s wager has been received and successfully processed by the system 100. This visual feedback reassures the user that their bet is locked in and recorded. As described above, in relation to the process 200 (shown in FIG. 2), the system 100 stores the user’s wager in the memory 118 and/or the database 120 (shown in FIGS. 1A and 1B), waiting for the event outcome to be revealed after the betting window closes.

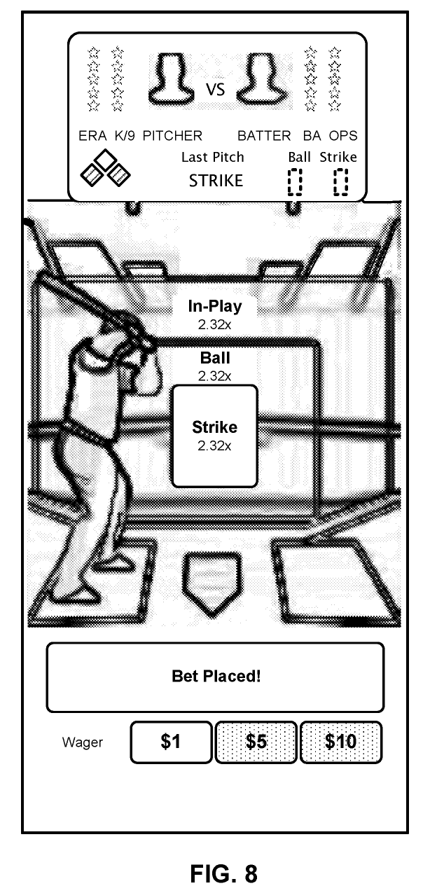

In the embodiment of FIG. 8, the UI transitions to a results stage where the outcome of the next pitch is revealed. If the user’s wager on a strike was successful, the UI will display the message "Win!" along with the amount won based on the initial wager and multiplier. The system 100 retrieves the full details of the historical event from the memory 118 or database 120 and reveals them to the user, including whether the pitch was indeed a strike, ball, or resulted in play. This step mirrors the final stage in the process 200 (shown in FIG. 2), where the system 100 reveals the full event details and settles the wager based on the revealed outcome.

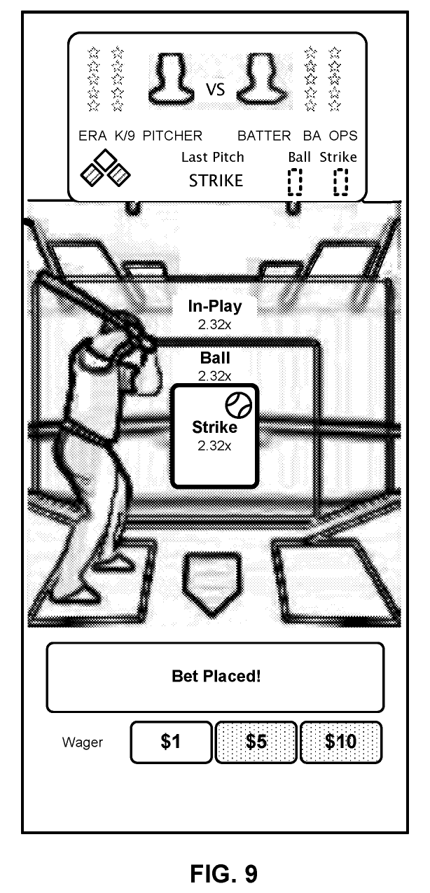

In the embodiment of FIG. 9, the UI can similarly display whether the user lost the wager if the outcome differed from their bet.

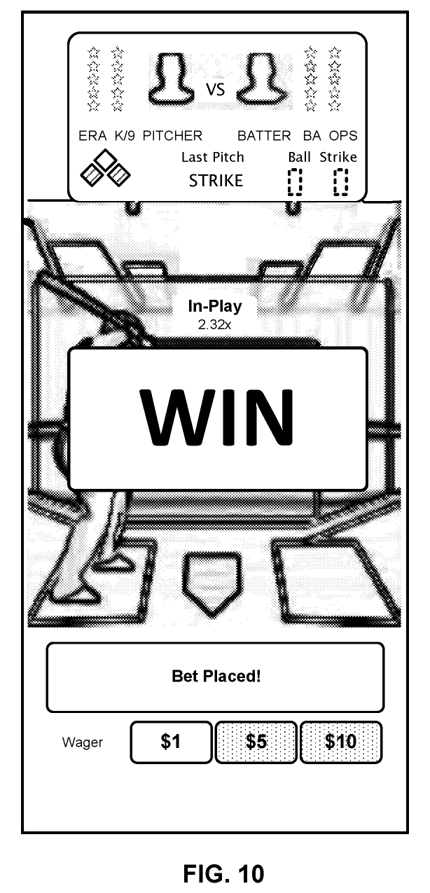

In the embodiment of FIG. 10, the UI summarizes the results of the wager, including the original bet amount, the selected option, and the final outcome of the event. This provides a clear breakdown of the user’s betting session, allowing them to verify their results. As described above, with respect to the operations of the process 300 (shown in FIG. 3), the system 100 can also log this transaction, including the market ordering strategy used and the wager result, to ensure compliance with regulatory requirements.

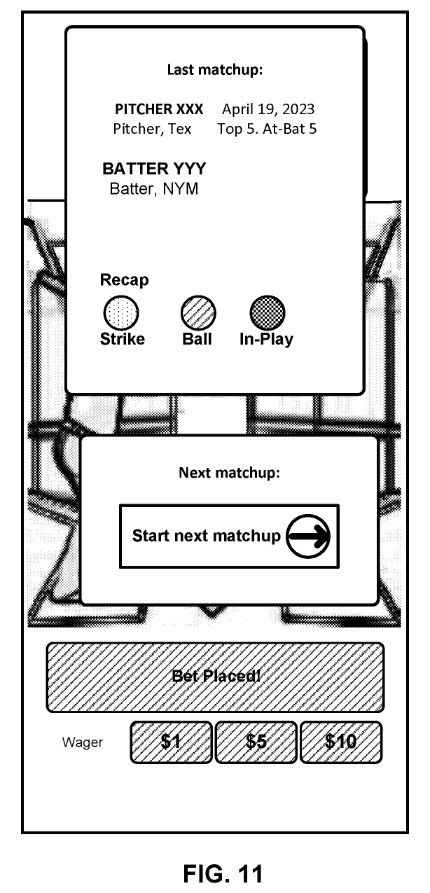

In the embodiment of FIG. 11, the UI introduces the next event and provides a recap of the previous wager’s outcome. The user can see an overview of the previous matchup and the result of the markets, and of the upcoming pitch, complete with anonymized statistics for the next pitcher and batter. The system 100 again retrieves anonymized historical sports data, using one of several market ordering strategies, as described above with respect to operation of the process 300 (shown in FIG. 3), allowing the user to place a new wager. By dynamically presenting ordered markets through the CMs 140 (shown in FIGS. 1A and 1B), the system 100 ensures that each new market is surfaced in a fair and engaging way.

In these embodiments, the system 100 provides an engaging and transparent wagering experience by allowing users to place bets on anonymized historical sports events while maintaining the integrity of the market. The UI design simplifies the betting process while offering key information. The system 100 can be configured to ensure that the presentation, anonymization, and settlement of wagers follow the operations of the processes 200 (shown in FIG. 2) and 300 (shown in FIG. 3). This provides users with a secure, fair, and engaging platform for sports wagering, supported by a robust technical framework.

The terms “a,” “an,” and “the,” as used in this disclosure, means “one or more,” unless expressly specified otherwise.

The term “activity,” as used in this disclosure with regard to a communicating device, means an input, entry, instruction, selection, action, or any interaction with the communicating device by a client-side user that can cause the communicating device to perform or carry out a process, task, function, or operation. An “activity” can include, for example, launching a client app such as a web browser in the communicating device or interacting with the client app to find, fetch, load, process, or render a computer resource based on a sequence of input data or instructions (for example, an entry comprising a single or a sequence of natural language terms).

The term “backbone,” as used in this disclosure, means a transmission medium or infrastructure that interconnects one or more computing devices or communicating devices to provide a path that conveys data packets or instructions between the computing devices or communicating devices. The backbone can include a network. The backbone can include an ethernet TCP/IP. The backbone can include a distributed backbone, a collapsed backbone, a parallel backbone or a serial backbone.

The term “bus,” as used in this disclosure, means any of several types of bus structures that can further interconnect to a memory bus (with or without a memory controller), a peripheral bus, or a local bus using any of a variety of commercially available bus architectures. The term “bus” can include a backbone.

The term “peripheral device,” “communicating device” or “communication device,” as used in this disclosure, means any computing device, hardware, or computing resource that can transmit or receive digital or analog signals or data packets, or instruction signals or data signals over a communication link. The device can be portable or stationary.

The term “communication link,” as used in this disclosure, means a wired and/or wireless medium that conveys data or information between at least two points. The wired or wireless medium can include, for example, a metallic conductor link, a radio frequency (RF) communication link, an Infrared (IR) communication link, or an optical communication link. The RF communication link can include, for example, GSM voice calls, SMS, EMS, MMS messaging, CDMA, TDMA, PDC, WCDMA, CDMA2000, GPRS, WiFi, WiMAX, IEEE 802.11, DECT, 0G, 1G, 2G, 3G, 4G, 5G, or 6G cellular standards, or Bluetooth. A communication link can include, for example, an RS-232, RS-422, RS-485, or any other suitable interface.

The terms “computer” or “computing device,” as used in this disclosure, means any machine, device, circuit, component, or module, or any system of machines, devices, circuits, components, or modules, which can be capable of manipulating data according to one or more instructions, such as, for example, without limitation, a processor, an application specific integrated circuit (ASIC), a field programmable gate array (FPGA), a microprocessor (μP), a central processing unit (CPU), a graphic processing unit (GPU), a general purpose computer, a super computer, a personal computer, a laptop computer, a palmtop computer, a notebook computer, a smart phone, a mobile phone, a tablet, a desktop computer, a workstation computer, a server, a server farm, a computer cloud, or an array of processors, ASICS, FPGAs, μPs, CPUs, GPUs, general purpose computers, super computers, personal computers, laptop computers, palmtop computers, notebook computers, desktop computers, workstation computers, or servers. A computer or computing device can include hardware, firmware, or software that can transmit or receive data packets or instructions over a communication link. The computer or computing device can be portable or stationary.

The term “computer resource,” as used in this disclosure, means software, a software application, a web application, a webpage, a document, a file, a record, an application program(ming) interface (API), web content, a computer application, a computer program, computer code, machine executable instructions, or firmware. A computer resource can include an information resource. A computer resource can include machine instructions for a programmable computing device, and can be implemented in a high-level procedural or object-oriented programming language, or in assembly/machine language.

The term “computer-readable medium,” as used in this disclosure, means any storage medium that participates in providing data (for example, instructions) that can be read by a computer. Such a medium can take many forms, including non-volatile media and volatile media. Non-volatile media can include, for example, optical or magnetic disks and other persistent memory. Volatile media can include dynamic random access memory (DRAM). Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read. The computer-readable medium can include a “Cloud,” which includes a distribution of files across multiple (e.g., thousands of) memory caches on multiple (e.g., thousands of) computers. The computer-readable medium can include magnetic discs, optical disks, memory, or Programmable Logic Devices (PLDs).

Various forms of computer readable media can be involved in carrying sequences of instructions to a computer. For example, sequences of instruction (i) can be delivered from a RAM to a processor, (ii) can be carried over a wireless transmission medium, and/or (iii) can be formatted according to numerous formats, standards or protocols, including, for example, WiFi, WiMAX, IEEE 802.11, DECT, 0G, 1G, 2G, 3G, 4G, 5G, or 6G cellular standards, or Bluetooth.

The term “database,” as used in this disclosure, means any combination of software and/or hardware, including at least one application and/or at least one computer. The database can include a structured collection of records or data organized according to a database model, such as, for example, but not limited to at least one of a relational model, a hierarchical model, or a network model. The database can include a database management system application (DBMS). The at least one application may include, but is not limited to, for example, an application program that can accept connections to service requests from clients by sending back responses to the clients. The database can be configured to run the at least one application, often under heavy workloads, unattended, for extended periods of time with minimal human direction.

The terms “including,” “comprising” and variations thereof, as used in this disclosure, mean “including, but not limited to,” unless expressly specified otherwise.

The term “information resource,” as used in this disclosure means, but is not limited to, computer code or computer executable instructions that cause content to be displayed on a display device, or to invoke a function to display the content such as on a website or webpage that includes primary content or a search results landing page provided by a search engine.

The term “network,” as used in this disclosure means, but is not limited to, for example, at least one of a personal area network (PAN), a local area network (LAN), a wireless local area network (WLAN), a campus area network (CAN), a metropolitan area network (MAN), a wide area network (WAN), a metropolitan area network (MAN), a wide area network (WAN), a global area network (GAN), a broadband area network (BAN), a cellular network, a storage-area network (SAN), a system-area network, a passive optical local area network (POLAN), an enterprise private network (EPN), a virtual private network (VPN), the Internet, or any combination of the foregoing, any of which can be configured to communicate data via a wireless and/or a wired communication medium. These networks can run a variety of protocols, including, but not limited to, for example, Ethernet, IP, IPX, TCP, UDP, SPX, IP, IRC, HTTP, FTP, Telnet, SMTP, DNS, ARP, ICMP.

The term “server,” as used in this disclosure, means any combination of software and/or hardware, including at least one application and/or at least one computer to perform services for connected clients as part of a client-server architecture. The at least one server application can include, but is not limited to, for example, an application program that can accept connections to service requests from clients by sending back responses to the clients. The server can be configured to run the at least one application, often under heavy workloads, unattended, for extended periods of time with minimal human direction. The server can include a plurality of computers configured, with the at least one application being divided among the computers depending upon the workload. For example, under light loading, the at least one application can run on a single computer. However, under heavy loading, multiple computers can be required to run the at least one application. The server, or any if its computers, can also be used as a workstation.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential or a parallel order, such processes, methods and algorithms may be configured to work in alternate orders. In other words, any sequence or order of steps that may be described in a sequential order does not necessarily indicate a requirement that the steps be performed in that order; some steps may be performed simultaneously. Similarly, if a sequence or order of steps is described in a parallel (or simultaneous) order, such steps can be performed in a sequential order. The steps of the processes, methods or algorithms described herein may be performed in any order practical.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

What is claimed is:

1. A sports wagering system for presenting anonymized historical sports markets, the system comprising:
a database;
a memory having a program comprising executable instructions; and
a processor communicatively coupled to the memory and the database, the processor being configured to execute a plurality of instructions, including to:
retrieve historical sports data from the database, the historical sports data corresponding to a sports event and one or more statistics, and identity data comprising one or more of a team identity and player identity related to the sports event;
anonymize the historical sports data;
transmit, via a transceiver, the anonymized historical sports data to a peripheral device, wherein the anonymized historical sports data comprises the one or more statistics related to the sports event;
receive, via the transceiver, a communication signal from the peripheral device comprising user wager data, including user input during a wagering period, the user wager data comprising one or more wagers based on the anonymized historical sports data;
store the user wager data in the database;
transmit, via the transceiver, the historical sports data to the peripheral device to display the one or more statistics related to the anonymized historical sports data after the wagering period ends; and
generate a wager settlement to settle the one or more wagers based on the historical sports data, the wager settlement being based on at least an event result related to the historical sports event.

2. The system of claim 1, wherein the processor is configured to provide the anonymized historical sports data by applying data masking to the identity data.

3. The system of claim 1, wherein the anonymized historic sports data is displayed by the peripheral device on a user interface, including display of one or more of a pitcher's Earned Run Average (ERA) and a batter’s Batting Average.

4. The system of claim 1, wherein the processor is further configured to retrieve the historical sports data from the database using indexing based on a market identifier or event type.

5. The system of claim 1, further comprising:
a machine learning model configured to recommend sports markets to the peripheral device based on past interactions.

6. The system of claim 1, wherein the database is configured to store metadata related to historical sports events, the metadata comprising one or more timestamps and regulatory information.

7. The system of claim 1, wherein the processor is further configured to execute instructions to transmit updates to the peripheral device in real-time using WebSockets or Server-Sent Events (SSE) to display live data.

8. A computer-implemented method for presenting anonymized historical sports markets, the method comprising:
retrieving, by a processor, historical sports data from a database, the historical sports data corresponding to a sports event and one or more statistics, and identity data comprising one or more of a team identity and player identity related to the sports event;
anonymizing, by the processor, the historical sports data related to the sports event;
transmitting, by a transceiver, the anonymized historical sports data to a peripheral device, wherein the anonymized historical sports data comprises the one or more statistics related to the sports event;
receiving, by the transceiver, a communication signal from the peripheral device comprising user wager data, the user wager data including a user input during a wagering period, the user wager data comprising one or more wagers based on the anonymized historical sports data;
storing, by the processor, the one or more wagers in the database;
transmitting, by the transceiver, the historical sports data to the peripheral device to present the one or more statistics related to the anonymized historical sports data after the wagering period ends; and
generating, by the processor, a wager settlement to settle the one or more wagers based on the historical sports data, the wager settlement being based on at least an event result related to the historical sports event.

9. The method of claim 8, wherein the anonymizing comprises applying data masking to the identity data.

10. The method of claim 8, further comprising:
providing, by the processor, statistics in the anonymized historical sports data, including a pitcher's Earned Run Average (ERA) and a batter’s Batting Average.

11. The method of claim 8, further comprising:
retrieving, by the processor, the historical sports data from the database using an indexing method based on a market identifier or event type.

12. The method of claim 8, further comprising:
recommending, by the processor, a sports market for the user based on previous interactions with the peripheral device.

13. The method of claim 8, further comprising:
storing, by the processor, metadata related to historical sports events, including timestamps and regulatory information, in the database.

14. The method of claim 8, further comprising:
transmitting, by the transceiver, updates to the peripheral device in real-time using WebSockets or Server-Sent Events (SSE) to present live data on a user interface.

15. The method of claim 8, further comprising:
receiving, by the transceiver, a communication signal from the peripheral device, the communication signal including data for a user selection of a preferred market ordering strategy from a plurality of available ordering strategies, including ordering by timestamps or UUIDs.

16. A non-transitory tangible computer-readable medium having instructions stored thereon that, when executed by a computing device, cause the computing device to perform operations comprising:
retrieving historical sports data from a database, the historical sports data corresponding to a sports event and one or more statistics, and identity data comprising one or more of a team identity and player identity related to the sports event;
anonymizing the historical sports data related to the sports event;
transmitting, via a transceiver, the anonymized historical sports data to a peripheral device, wherein the anonymized historical sports data comprises the one or more statistics related to the sports event;
receiving, via the transceiver, user input data from the peripheral device during a wagering period, the user input data comprising one or more wagers based on the anonymized historical sports data;
storing the one or more wagers in the database;
transmitting, via the transceiver, the historical sports data to the peripheral device to reveal the one or more statistics related to the anonymized historical sports data after the wagering period ends; and
generating a wager settlement to settle the one or more wagers based on the historical sports data, the wager settlement being based on at least an event result related to the historical sports event.

17. The non-transitory computer-readable medium of claim 16, wherein the anonymizing comprises applying data masking to the identity data.

18. The non-transitory computer-readable medium of claim 16, wherein the operations further comprise:
transmitting, via the transceiver, statistics data in the anonymized historical sports data, including a pitcher's Earned Run Average (ERA) and a batter’s Batting Average.

19. The non-transitory computer-readable medium of claim 16, wherein the operations further comprise”
retrieving, from the database, the historical sports data using an indexing method based on a market identifier or event type.

20. The non-transitory computer-readable medium of claim 16, wherein the operations further comprise:
transmitting, via the transceiver, data and instructions to the peripheral device for presenting real-time updates to the user interface using WebSockets or Server-Sent Events (SSE) to provide live data to the user.
